(19) United States
(12) Patent Application Publication
(10) Pub. No.: US 2025/0267552 A1
(43) Pub. Date: Aug. 21, 2025

(54) UPDATING SYSTEM INFORMATION IN A NON-TERRESTRIAL NETWORK

(71) Applicant: QUALCOMM Incorporated, San Diego, CA (US)

(72) Inventors: Jae Ho RYU, San Diego, CA (US); Xiao Feng WANG, San Diego, CA (US); Bharat SHRESTHA, San Diego, CA (US); Changhwan PARK, San Diego, CA (US)

(21) Appl. No.: 18/443,148

(22) Filed: Feb. 15, 2024

(51) Int. Cl. H04W 48/08; H04B 7/185; H04L 1/1867

(52) U.S. Cl. CPC H04W 48/08; H04B 7/18513; H04L 1/1887

(57) ABSTRACT

Various aspects of the present disclosure generally relate to wireless communication. In some aspects, a user equipment (UE) may receive a configuration associated with a system information block 19 (SIB19). The UE may receive the SIB19 based at least in part on the configuration. The UE may transmit an uplink transmission that has an uplink synchronization based at least in part on the SIB19. Numerous other aspects are described.

### INTRODUCTION

Aspects of the present disclosure generally relate to wireless communication and specifically relate to techniques, apparatuses, and methods for updating system information in a wireless network.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a user equipment (UE). The apparatus may include one or more memories and one or more processors coupled to the one or more memories. The one or more processors may be configured to receive a configuration associated with a system information block 19 (SIB19). The one or more processors may be configured to receive the SIB19 based at least in part on the configuration. The one or more processors may be configured to transmit an uplink transmission that has an uplink synchronization based at least in part on the SIB19.

Some aspects described herein relate to an apparatus for wireless communication at a network node. The apparatus may include one or more memories and one or more processors coupled to the one or more memories. The one or more processors may be configured to transmit a configuration associated with a SIB19. The one or more processors may be configured to receive an uplink transmission that has an uplink synchronization based at least in part on the SIB19.

Some aspects described herein relate to a method of wireless communication performed at a UE. The method may include receiving a configuration associated with a SIB19. The method may include receiving the SIB19 based at least in part on the configuration. The method may include transmitting an uplink transmission that has an uplink synchronization based at least in part on the SIB19.

Some aspects described herein relate to a method of wireless communication performed at a network node. The method may include transmitting a configuration associated with a SIB19. The method may include receiving an uplink transmission that has an uplink synchronization based at least in part on the SIB19.

Some aspects described herein relate to a non-transitory computer-readable medium that stores a set of instructions for wireless communication by a UE. The set of instructions, when executed by one or more processors of the UE, may cause the UE to receive a configuration associated with a SIB19. The set of instructions, when executed by one or more processors of the UE, may cause the UE to receive the SIB19 based at least in part on the configuration. The set of instructions, when executed by one or more processors of the UE, may cause the UE to transmit an uplink transmission that has an uplink synchronization based at least in part on the SIB19.

Some aspects described herein relate to a non-transitory computer-readable medium that stores a set of instructions for wireless communication by a network node. The set of instructions, when executed by one or more processors of the network node, may cause the network node to transmit a configuration associated with a SIB19. The set of instructions, when executed by one or more processors of the network node, may cause the network node to receive an uplink transmission that has an uplink synchronization based at least in part on the SIB19.

Some aspects described herein relate to an apparatus for wireless communication. The apparatus may include means for receiving a configuration associated with a SIB19. The apparatus may include means for receiving the SIB19 based at least in part on the configuration. The apparatus may include means for transmitting an uplink transmission that has an uplink synchronization based at least in part on the SIB19.

Some aspects described herein relate to an apparatus for wireless communication. The apparatus may include means for transmitting a configuration associated with a SIB19. The apparatus may include means for receiving an uplink transmission that has an uplink synchronization based at least in part on the SIB19.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a non-terrestrial network (NTN) architecture, in accordance with the present disclosure.

FIG. 5 is a diagram illustrating an example of an ephemeris update in an NTN, in accordance with the present disclosure.

FIG. 6 is a diagram illustrating an example of system information block (SIB) scheduling information, in accordance with the present disclosure.

FIG. 7 is a diagram illustrating an example of a collision between an uplink slot and a SIB19 reading slot, in accordance with the present disclosure.

FIGS. 8-12 are diagrams illustrating examples associated with updating system information (SI) in an NTN, in accordance with the present disclosure.

FIGS. 13-14 are diagrams illustrating example processes associated with updating SI in an NTN, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example of an implementation of code and circuitry for an apparatus, in accordance with the present disclosure.

FIG. 18 is a diagram of an example apparatus for wireless communication, in accordance with the present disclosure.

FIG. 19 is a diagram illustrating an example of a hardware implementation for an apparatus employing a processing system, in accordance with the present disclosure.

FIG. 20 is a diagram illustrating an example of an implementation of code and circuitry for an apparatus, in accordance with the present disclosure.

### DETAILED DESCRIPTION

A network node may serve user equipments (UEs) that support different capabilities. For example, the network node may serve a first category of UEs that have less advanced capabilities and a second category of UEs that have more advanced capabilities. In one aspect, a UE of the first category may have a reduced feature set compared to UEs of the second category, and may be referred to as a reduced capability (RedCap) UE or an enhanced reduced capability (eRedCap UE). A UE of the second category may have an advanced feature set compared to UEs of the first category. For example, a UE of the first category may be a half-duplex (HD) UE, whereas a UE of the second category may be a full-duplex (FD) UE. An FD UE may be able to transmit and receive at the same time, whereas an HD UE may only be able to transmit or receive (but not both) at any given time. The HD UE may not support simultaneous uplink and downlink transmissions, which may reduce complexity and/or cost at the HD UE. A FD capability may be considered to be more advanced than an HD capability.

A UE may operate in a terrestrial network (TN) or in a non-terrestrial network (NTN). In the TN, the UE may communicate with the network node via a ground-based signaling, whereas in the NTN, the UE may communicate with the network node via a satellite or another type of artificial body placed in orbit around the Earth. The satellite may be a low Earth orbit (LEO) satellite, a medium Earth orbit (MEO) satellite, a geostationary (GEO) satellite, or any other type of suitable satellite. In the NTN, signals may be communicated between the UE and the network node via the satellite.

In the TN, for an HD UE, when a downlink transmission overlaps in time with at least one symbol of an uplink transmission, the HD UE may drop the downlink transmission. In other words, in the TN, the HD UE may prioritize the uplink transmission, so the HD UE may keep the uplink transmission and discard receiving the downlink transmission. However, in the NTN, the HD UE may not (e.g., should not) drop a system information block 19 (SIB19) received in a downlink direction in favor of the uplink transmission during a collision. In the NTN, the network node may periodically transmit, in the downlink direction, the SIB19 to indicate updated satellite ephemeris information and common timing advance (TA) parameters, which the UE may use for an uplink synchronization with the network node. The common TA parameters may include a common TA to be received and applied by UEs in a same NTN cell. The satellite ephemeris information may indicate a satellite location and/or velocity at a specific epoch time. The common TA parameters may indicate propagation delay in the feeder link. The satellite ephemeris information may be valid at a reference time for uplink synchronization, and the reference time may be denoted by the epoch time. In the NTN, since serving satellites move at relatively fast speeds, in contrast to a TN architecture, the NTN may periodically update the satellite ephemeris information and common TA parameters. Without the uplink synchronization, the network node may not receive uplink transmissions from different UEs, including the UE, in a synchronous manner (e.g., with a same timing and/or frequency from the network point of view), which may result in the UE having to periodically receive the SIB19 to maintain the uplink synchronization with the network node. The SIB19 is to be periodically received by the UE in the downlink direction and may not be dropped, otherwise the UE may be unable to maintain the uplink synchronization using the updated satellite ephemeris information in the SIB19. When the uplink synchronization is lost, the UE may be barred from performing uplink transmissions until the uplink synchronization is restored.

The UE, such as an HD UE in the NTN, may need to periodically update the satellite ephemeris information and common TA parameters by receiving the SIB19 to maintain the uplink synchronization. As used herein, “receiving the SIB19” is used interchangeably with ‘reading the SIB19”. The periodic update of the SIB19 may be unique to the NTN. In the TN, the UE may be required to update any SIB when a network node indicates that the SIB has changed by paging, which may occur after a significant network configuration change. In one example, when the UE is the HD UE, the UE may not be available for an uplink transmission during a SIB19 reception due to the HD capability of the UE. A legacy HD UE behavior may be to drop a reception of a downlink transmission, but such behavior may conflict with an NTN UE requirement for periodic SIB19 updating. In the NTN, when the UE drops a reception of the SIB19, the uplink synchronization may be lost (e.g., due to the UE not receiving the updated satellite ephemeris information in the SIB19, which may be needed to maintain the uplink synchronization) and the UE may be unable to perform uplink transmissions with the network node, thereby degrading an overall performance of the UE. For example, the uplink transmissions may be associated with a voice call, and the loss of uplink synchronization may cause the voice call to be interrupted or dropped, which may degrade the overall performance of the UE.

Various aspects relate generally to updating system information (SI) in an NTN. In some aspects, a UE may receive, from a network node and in downlink direction, a configuration associated with reading the SIB19. The SIB19 may be a system information block (SIB) that provides NTN-specific parameters for a serving cell and/or neighbor cells. The SIB19 may indicate satellite assistance information, such as satellite ephemeris information, common TA parameters, epoch time, and/or a validity duration of the satellite assistance information. The validity duration may be configured by the network node and may correspond to a maximum time during which the UE is able to apply assistance information without having acquired new assistance information. The configuration may indicate that a reception of the SIB19 is to be prioritized over an uplink transmission when the uplink transmission overlaps in time with the reception of the SIB19. The SIB19 in the downlink direction may collide with the uplink transmission when the UE is an HD UE (e.g., capable of only a downlink transmission or an uplink transmission at a given time). A collision may occur when the SIB19 is attempted to be received in a same subframe in which the uplink transmission is attempted to be transmitted, such that the reception of the SIB19 and the uplink transmission may at least partially overlap in time. The configuration may indicate one or more SIB19 update windows, during which the UE may monitor a search space for reading the SIB19. The configuration may indicate a sub-window of a SIB19 update window, during which the UE may monitor the search space for reading the SIB19. In other words, the configuration may indicate specific designated time periods during which the UE is able to monitor for the SIB19. The UE may monitor the search space for reading the SIB19, which may be based at least in part on the SIB19 window or sub-window indicated in the configuration.

In some aspects, the UE may receive the SIB19 in an SI update window, in the SIB19 update window configured via the configuration, or in the sub-window configured via the configuration. When the reception of the SIB19 overlaps in time with the uplink transmission, the UE may drop the uplink transmission and keep monitoring the SIB19 in accordance with the configuration. In other words, even though the reception of the SIB19 overlaps with the uplink transmission, the UE may prioritize the reception of the SIB19 and deprioritize the uplink transmission, which may be based at least in part on the relative importance of receiving the SIB19. The UE may transmit, to the network node and after receiving the SIB19, an uplink transmission that has an uplink synchronization based at least in part on the SIB19. The uplink synchronization may be based at least in part on updated satellite ephemeris information and common TA parameters indicated in the SIB19.

In some examples, by configuring the UE to receive the SIB19 in the SIB update window or the sub-window, or by configuring the UE to drop an uplink transmission to keep monitoring the SIB19, the described techniques may be used by the UE to successfully receive the SIB19 in the presence of a collision with the uplink transmission. The UE may prioritize the SIB19 instead of the uplink transmission when the uplink transmission collides with the SIB19, which may be based at least in part on the configuration. When the SIB19 is not received within a validity duration (e.g., a timer, such as a T430 timer, expires to indicate an end of the validity duration), the UE may be unable to maintain the uplink synchronization with the network node and the UE may be unable to perform uplink transmissions until the uplink synchronization is restored. The UE may start the timer at a start of the validity duration, and when the SIB19 is not received before the expiry of the timer (which corresponds to the end of the validity duration), uplink synchronization may no longer be valid. By ensuring that the SIB19 is periodically received by prioritizing the SIB19 over the uplink transmission, the UE may be able to maintain the uplink synchronization, and the UE may experience fewer interruptions with uplink signaling (e.g., uplink signaling associated with a voice call), thereby improving an overall performance of the UE.

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

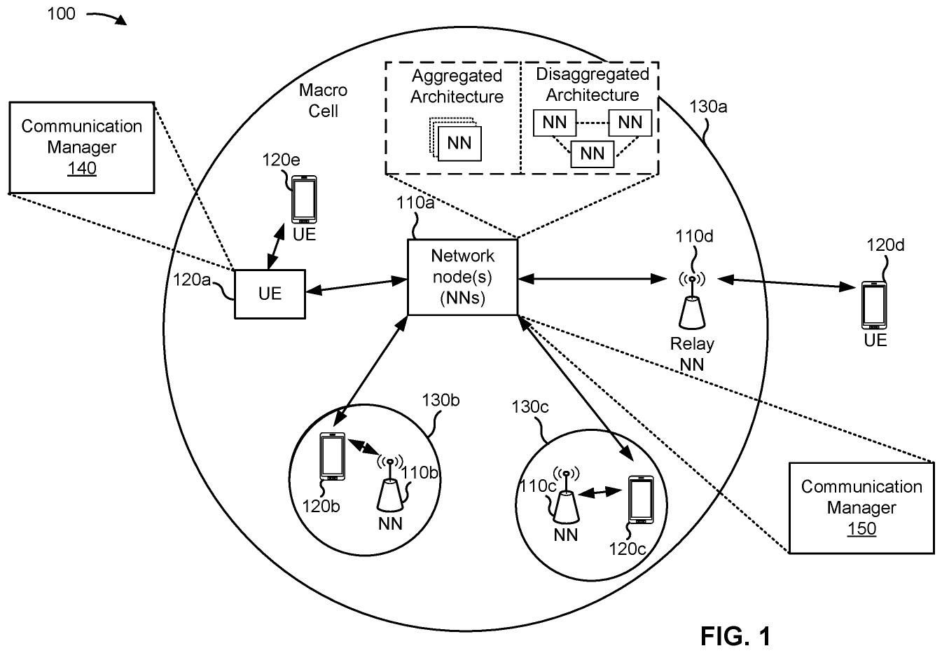

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). A processor also may be implemented as a combination of computing devices, for example, a combination of a DSP and a microprocessor, a plurality of microprocessors, one or more microprocessors in conjunction with a DSP core, or any other such configuration. One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., the UE 120) may include a communication manager 140. As described in more detail elsewhere herein, the communication manager 140 may receive a configuration associated with a SIB19; receive the SIB19 based at least in part on the configuration; and transmit an uplink transmission that has an uplink synchronization based at least in part on the SIB19. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a configuration associated with a SIB19; and receive an uplink transmission that has an uplink synchronization based at least in part on the SIB19. Additionally, or alternatively, the communication manager 150 may perform one or more other operations described herein.

As indicated above, FIG. 1 is provided as an example. Other examples may differ from what is described with regard to FIG. 1.

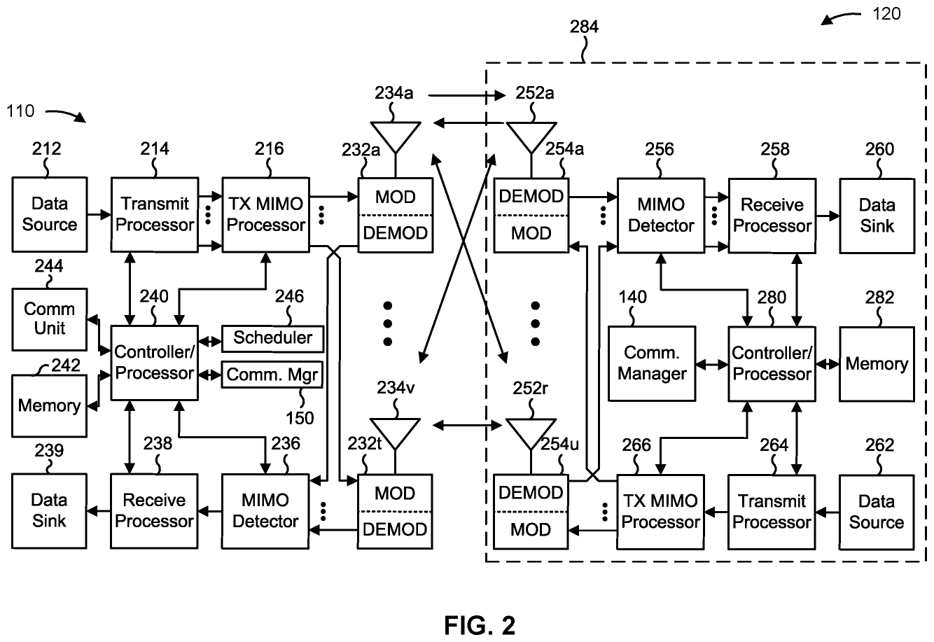

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

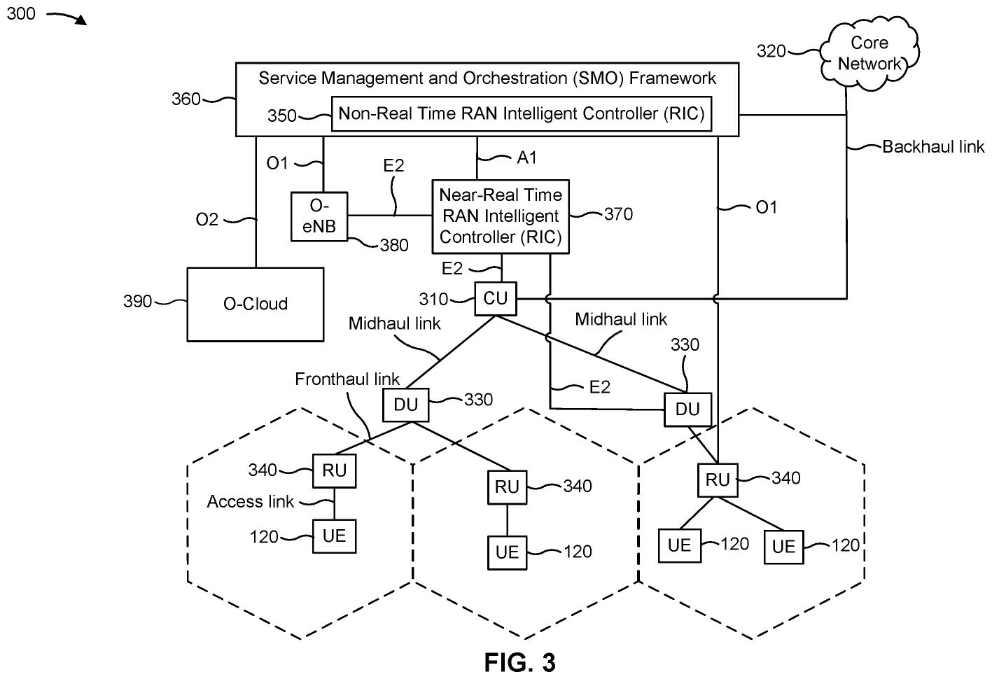

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

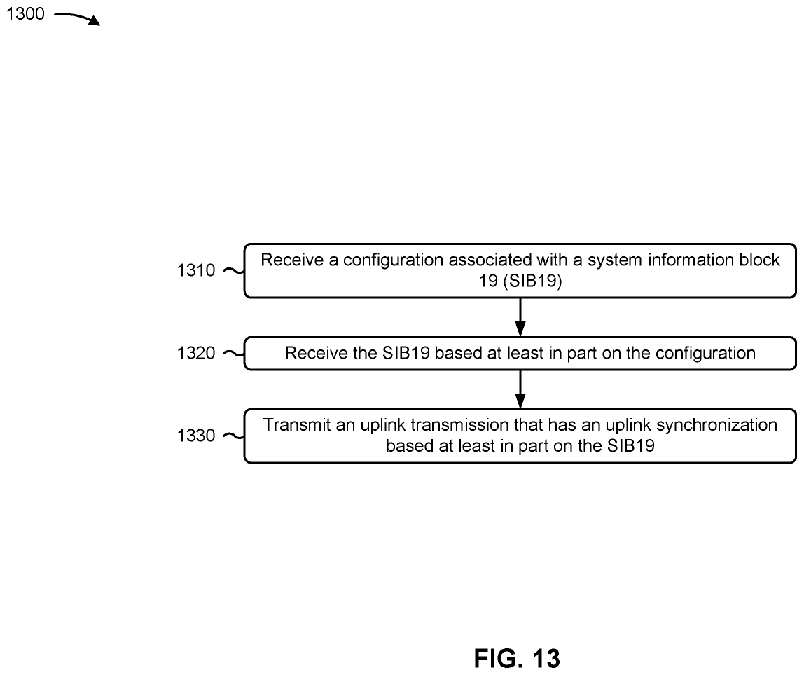

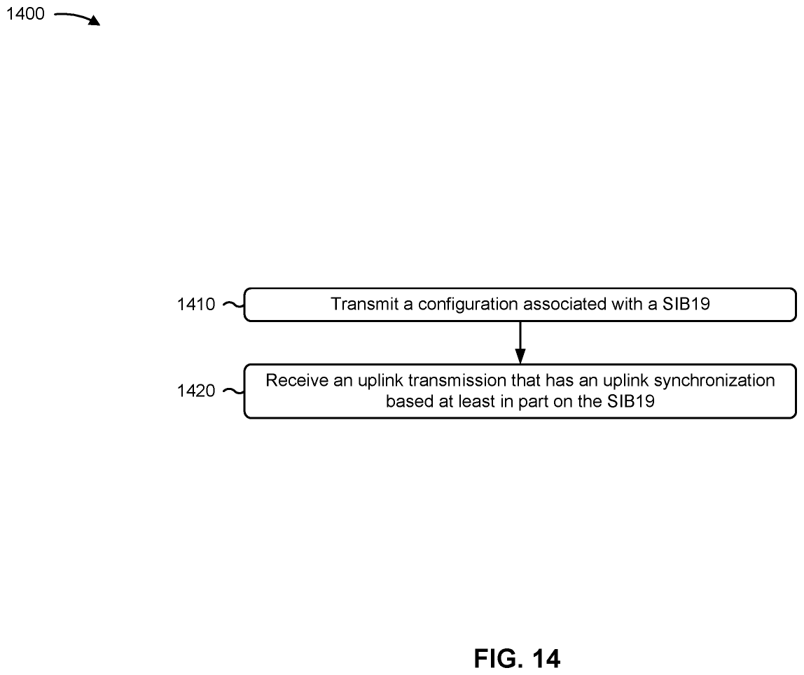

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with updating SI in an NTN, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13, process 1400 of FIG. 14, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, a UE (e.g., the UE 120) includes means for receiving a configuration associated with a SIB19; means for receiving the SIB19 based at least in part on the configuration; and/or means for transmitting an uplink transmission that has an uplink synchronization based at least in part on the SIB19. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a configuration associated with a SIB19; and/or means for receiving an uplink transmission that has an uplink synchronization based at least in part on the SIB19. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

A network node may serve different UEs of different categories and/or different UEs that support different capabilities. For example, the network node may serve a first category of UEs that have a less advanced capability (e.g., a lower capability and/or a reduced capability) and a second category of UEs that have a more advanced capability (e.g., a higher capability). A UE of the first category may have a reduced feature set compared to UEs of the second category, and may be referred to as a reduced capability (RedCap) UE, an enhanced reduced capability (eRedCap UE), a low tier UE, and/or an NR-Lite UE, among other examples. A UE of the first category may be, for example, an MTC UE, an eMTC UE, and/or an IoT UE. A UE of the second category may have an advanced feature set compared to UEs of the first category, and may be referred to as a baseline UE, a high tier UE, an NR UE, and/or a premium UE, among other examples.

For example, UEs of the first category may support a lower MCS than UEs of the second category (e.g., quadrature phase shift keying (QPSK) or the like as compared to 256-quadrature amplitude modulation (QAM) or the like), may support a lower maximum transmit power than UEs of the second category, may have a less advanced beamforming capability than UEs of the second category (e.g., may not be capable of forming as many beams as UEs of the second category), may require a longer processing time than UEs of the second category, may include less hardware than UEs of the second category (e.g., fewer antennas, fewer transmit antennas, and/or fewer receive antennas), and/or may not be capable of communicating on as wide of a maximum bandwidth part as UEs of the second category, among other examples. Additionally, or alternatively, UEs of the second category may be capable of communicating using a shortened transmission time interval (TTI) (e.g., a slot length of 1 ms or less, 0.5 ms, 0.25 ms, 0.125 ms, 0.0625 ms, or the like, depending on a sub-carrier spacing), and UEs of the first category may not be capable of communicating using the shortened TTI.

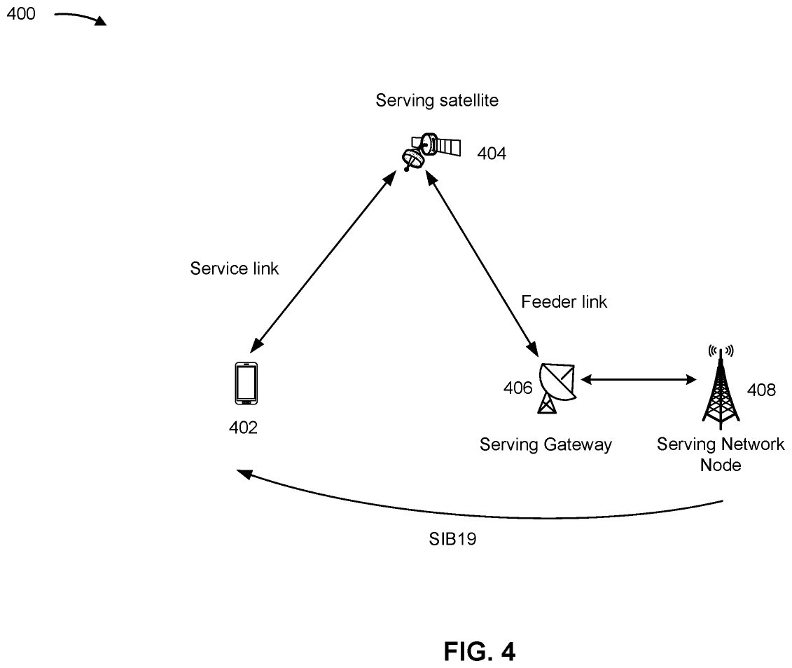

FIG. 4 is a diagram illustrating an example 400 of an NTN architecture, in accordance with the present disclosure.

As shown in FIG. 4, a UE 402 in a connected mode may communicate with a serving network node 408 via a serving satellite 404 in the NTN architecture. The UE 402 may transmit an uplink transmission to the serving satellite 404. The serving satellite 404 may relay the uplink transmission to the serving network node 408 via a serving gateway 406. The serving network node 408 may transmit a downlink transmission to the serving satellite 404 via the serving gateway 406. The serving satellite 404 may relay the downlink transmission to the UE 402. A link between the UE 402 and the serving satellite 404 may be a service link, and a link between the serving satellite 404 and the serving gateway 406 may be a feeder link. In some aspects, the serving network node 408 may transmit a SIB19 to the UE 402 via the serving satellite 404.

The UE 402, such as a RedCap UE or an eRedCap UE, may be associated with an NTN (e.g., an NR NTN) and operate in a frequency range 1 (FR1) NTN (FR1-NTN) band. The UE 402 may be a full-duplex (FD) frequency division duplexing (FDD) UE or a half-duplex (HD) FDD UE. The FD FDD UE may be able to transmit and receive at the same time, whereas the HD FDD UE may only be able to transmit or receive (but not both) at any given time. The HD FDD UE may not support simultaneous uplink and downlink transmissions.

As indicated above, FIG. 4 is provided as an example. Other examples may differ from what is described with regard to FIG. 4.

During a collision handling of the HD FDD UE in a terrestrial network (TN), when an RRC configured downlink transmission (e.g., a PDCCH transmission, a PDSCH transmission, a CSI-RS transmission, or a positioning reference signal (PRS) transmission) overlaps in time with at least one symbol of a dynamically scheduled uplink transmission (e.g., a PUCCH transmission, a PUSCH transmission, an SRS transmission, or a PRACH transmission), the HD FDD UE may drop the RRC configured downlink transmission. In other words, in the TN, the HD FDD UE may perform the dynamically scheduled UL transmission and drop the RRC configured downlink transmission.

However, in the NTN, the HD FDD UE should not drop the RRC configured downlink transmission in certain scenarios. A network node may periodically transmit, in a downlink direction, a system information block 19 (SIB19) to indicate updated satellite ephemeris information and common TA parameters, which the UE may use for an uplink Doppler/delay pre-compensation. The satellite ephemeris information may indicate a satellite location and/or velocity. Common TA parameters may indicate propagation delay in the feeder link. Such information must be periodically received by the UE and cannot be dropped, otherwise the UE may be unable to perform uplink transmissions. In the NTN, since serving satellites move at relatively fast speeds, in contrast to a TN architecture, the NTN is required to periodically update the satellite ephemeris information and common TA parameters. Without the uplink Doppler/delay pre-compensation, the network node may not receive uplink transmissions from different UEs in a synchronous manner (e.g., with a same timing and/or frequency from the network point of view). During a SIB19 update, the HD FDD UE may not be available for uplink transmission for a dynamically scheduled uplink channel/signal.

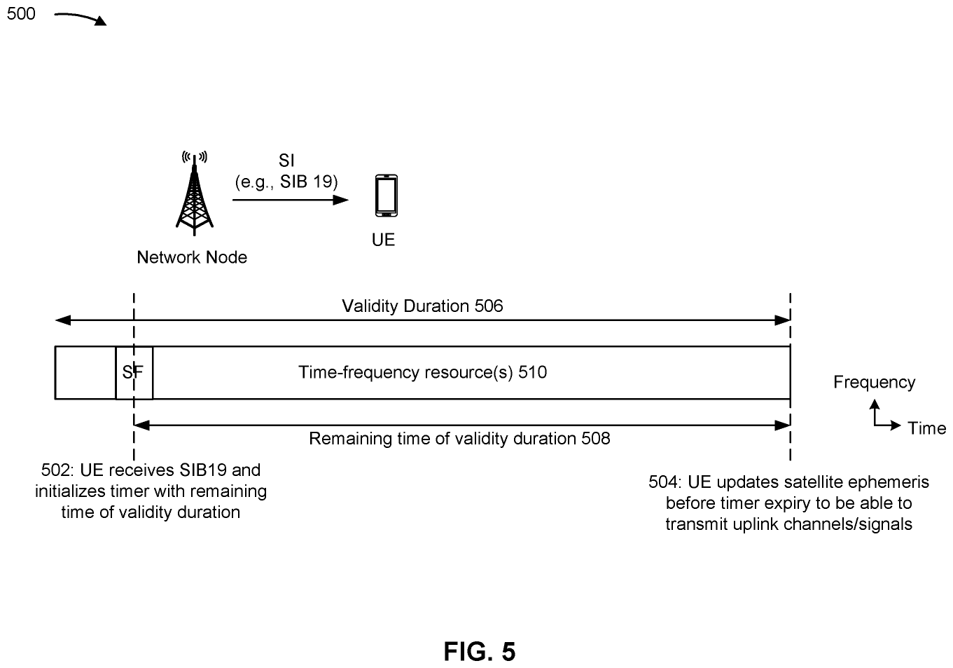

FIG. 5 is a diagram illustrating an example 500 of an ephemeris update in an NTN, in accordance with the present disclosure.

As shown by reference number 502, the UE may receive a SIB19 with satellite ephemeris information and common TA parameters during a validity duration 506. The UE may receive the SIB19 on a time-frequency resource 510. The validity duration 506 may be configured by a network node and may correspond to a maximum time during which the UE is able to apply assistance information without having acquired new assistance information. After the UE reads the SIB19, the UE may initialize a timer (e.g., a T430 timer) with a remaining time of the validity duration 508. As shown by reference number 504, the UE may update the satellite ephemeris information and common TA parameters (e.g., receive another SIB19 with updated information) before the timer expires to be able to transmit uplink channels/signals. The validity duration 506 (e.g., in seconds) may be associated with an NTN uplink synchronization validity duration (ntn-UlSyncValidityDuration) parameter, which may define a validity duration 506 configured by a network for uplink synchronization assistance information (e.g., serving satellite ephemeris and common timing advance (TA) parameters). For example, the validity duration may range from 5 seconds to 900 seconds. The NTN uplink synchronization validity duration may be one of the following values: s5, s10, s15, s20, s25, s30, s35, s40, s45, s50, s55, s60, s120, s180, s240, or s900, where “s” refers to seconds. The validity duration 506 may apply to both connected mode UEs and idle mode UEs. After receiving the SIB19, the UE may start or restart the timer with the duration ntn-UlSyncValidityDuration from a subframe (SF) indicated by an epoch time. The UE should attempt to reacquire the SIB19 before an end of a duration indicated by the ntn-UlSyncValidityDuration and the epoch time by UE implementation. When the timer expires, the UE may inform lower layers that an uplink synchronization is lost.

As indicated above, FIG. 5 is provided as an example. Other examples may differ from what is described with regard to FIG. 5.

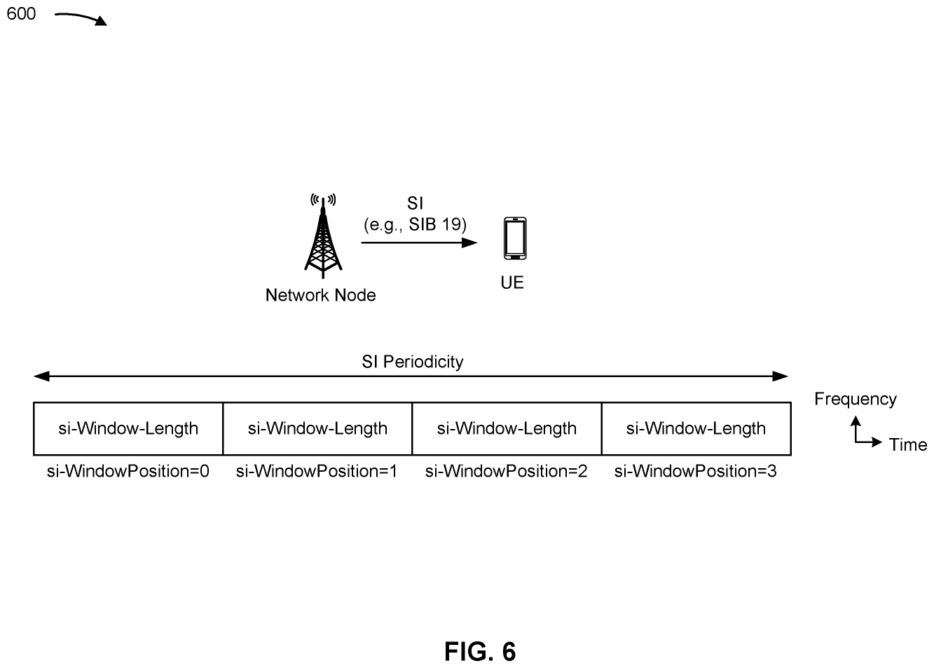

FIG. 6 is a diagram illustrating an example 600 of SIB scheduling information, in accordance with the present disclosure.

A network node may transmit SI, such as a SIB19, to a UE during an SI update window. The SI update window may be configured in a SIB1. A validity duration (e.g., as shown in FIG. 5) may include multiple SI periodicities, so a UE may have a flexibility to freely select an SI period for receiving the SIB19. Since the UE may be unaware of an exact slot within an SI window in which the network node schedules the SIB19, the UE may monitor a search space (e.g., a Type-GA search space) in all slots within the SI window associated with the SIB19. The network node may be unaware of which specific SI period the UE will monitor the search space for SIB19 reading.

As shown in FIG. 6, the network node may transmit SI, such as a SIB19, to the UE during an SI periodicity. The SI periodicity (si-Periodicity) may include a plurality of SI windows. An SI window may be associated with time-frequency resources. Each SI window may be associated with a same window length. The window length may be in terms of a number of slots. Each SI window may be associated with a position. The SIB19 may be transmitted in one of the SI windows associated with the SI periodicity.

An RRC configuration may define scheduling information (SchedulingInfo2-r17), which may indicate a broadcast status (si-BroadcastStatus-r17), an SI window position (si-WindowPosition-r17), an SI periodicity (si-Periodicity-r17), and SIB mapping information (sib-MappingInfo-r17). The SI window position may range from 1 to 256. The SI periodicity may be one of the following values: rf8, rf16, rf32, rf64, rf128, rf256, or rf512, where “rf” refers to radio frame. An RRC configuration may define SI scheduling information (SI-SchedulingInfo), which may indicate a scheduling information list (schedulingInfoList), an SI window length (si-WindowLength), an SI request configuration (si-RequestConfig), an SI request configuration for supplementary uplink (si-RequestConfigSUL), and a system information area identifier (systeminformationArealD). The SI window length may be one of the following values: s5, s10, s20, s40, s80, s160, s320, s640, s1280, s2560, or s5120).

As indicated above, FIG. 6 is provided as an example. Other examples may differ from what is described with regard to FIG. 6.

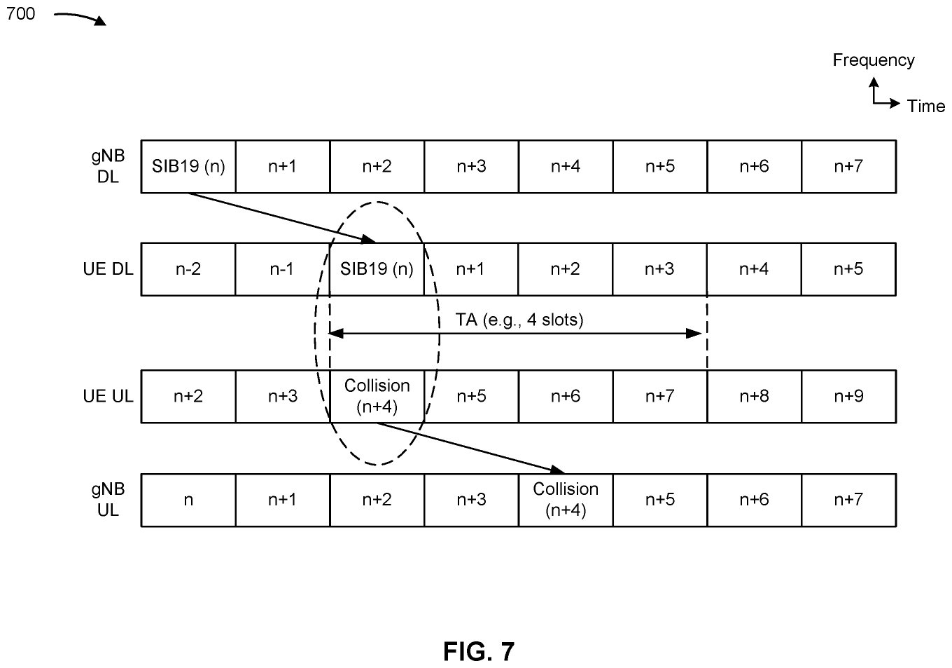

FIG. 7 is a diagram illustrating an example 700 of a collision between an uplink slot and a SIB19 reading slot, in accordance with the present disclosure.

As shown in FIG. 7, a network node may transmit a SIB19 in a downlink slot (slot n), which may be received at a UE with a two-slot delay, which may be based at least in part on a relatively large propagation delay associated with an NTN. A downlink slot in which the UE reads the SIB19 may collide with an uplink slot of the UE, which may result in an uplink and SIB19 collision. The network node may determine the UE's TA (e.g., 4 slots), which may allow the network node to determine an exact location of uplink slots colliding with SIB19 reception (or SIB19 reading slots). The TA may indicate a difference between a downlink slot timing and an uplink slot timing. The UE (e.g., an HD FDD UE) may support TA reporting to the network node. In other words, the UE may support information related to TA pre-compensation for NR communication via satellite.

As indicated above, FIG. 7 is provided as an example. Other examples may differ from what is described with regard to FIG. 7.

A UE, such as an NTN UE, may be required to periodically update satellite ephemeris information and common TA parameters by reading a SIB19 to maintain an uplink synchronization. The periodic updating of the SIB19 may be a unique problem in an NTN. In a TN, the UE may be required to update a SIB only when a network node indicates that the SIB has changed by paging, which may only occur after a significant network configuration change. When the UE is an HD FDD UE, the UE may not be available for a transmission of a dynamically scheduled uplink channel/signal during a SIB19 reading. A legacy HD FDD UE behavior may be to drop an RRC configured downlink transmission, but such behavior may conflict with an NTN UE requirement for periodic SIB19 update. In other words, the UE cannot drop the SIB19 transmission because the UE is required to periodically update the satellite ephemeris information and common TA parameters to maintain the uplink synchronization. For the HDD FDD UE in NTN, complete avoidance of collisions between semi-statically configured downlink and uplink scheduling may not be possible due to a time-varying TA. The HD FDD UE may not be configured for collision handling in the case where the UE has the dynamically scheduled uplink channel/signal at the same time as the SIB19 reading. The collision handling may be needed because the HD limitation prevents uplink and downlink transmissions from occurring at the same time. With the collision handling, the dynamically scheduled uplink channel/signal may collide with the SIB19 reading, which may cause the UE to not update the satellite ephemeris information and common TA parameters, thereby not maintaining the uplink synchronization. The UE may not be able to transmit any uplink channels/signals when uplink synchronization is lost, thereby degrading an overall performance of the UE.

In various aspects of techniques and apparatuses described herein, a UE may receive, from a network node, a configuration associated with reading a SIB19. The configuration may indicate that the SIB19 should be prioritized over an uplink transmission when the uplink transmission overlaps in time with the SIB19. The configuration may indicate one or more SIB19 update windows, during which the UE may monitor a search space for reading the SIB19. The configuration may indicate a sub-window of a SIB19 update window, during which the UE may monitor a search space for reading the SIB19. The UE may receive, from the network node, the SIB19 based at least in part on the configuration. The SIB19 may indicate updated satellite ephemeris information and common TA parameters. The UE may drop an uplink transmission that overlaps in time with the SIB19 based at least in part on the configuration. The UE may drop an uplink transmission within the SIB19 update window based at least in part on the configuration. The UE may transmit, to the network node, an uplink transmission that has an uplink synchronization based at least in part on the SIB19. The uplink synchronization may be based at least in part on the updated satellite ephemeris information and common TA parameters indicated in the SIB19.

In some aspects, by configuring the UE to be able to read the SIB19, the UE may be able to successfully receive the SIB19 in the presence of a collision with an uplink transmission. The UE may prioritize the SIB19 instead of the uplink transmission when the uplink transmission collides with the SIB19. When the SIB19 is not read within a certain time, the UE may be unable to maintain an uplink synchronization with a network node and the UE may be unable to perform uplink transmissions until the uplink synchronization is restored. By ensuring that the SIB19 is periodically received by prioritizing the SIB19 over the uplink transmission, the UE may be able to maintain the uplink synchronization, and the UE may experience fewer interruptions with uplink signaling (e.g., uplink signaling associated with a voice call), thereby improving an overall performance of the UE.

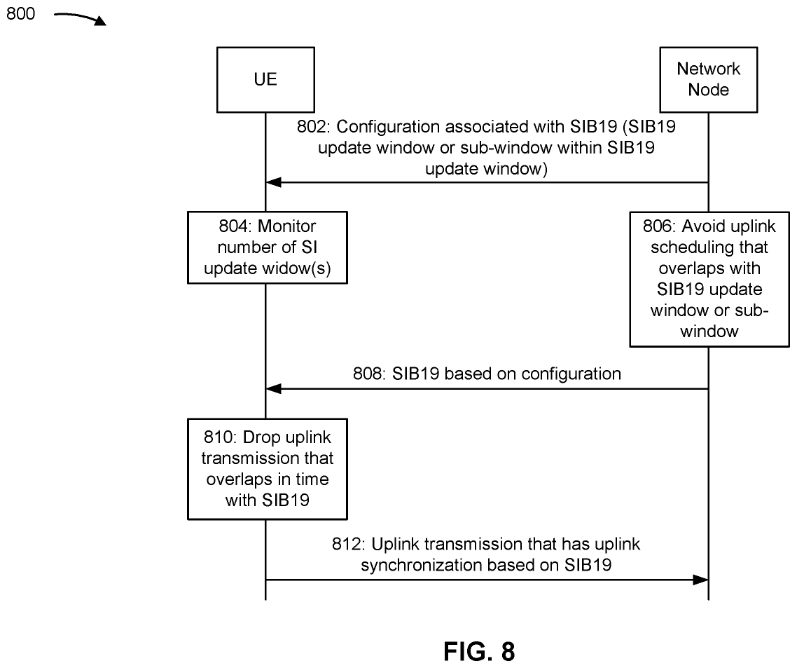

FIG. 8 is a diagram illustrating an example 800 associated with updating SI in an NTN, in accordance with the present disclosure. As shown in FIG. 8, example 800 includes communication between a UE (e.g., UE 120) and a network node (e.g., network node 110). In some aspects, the UE and the network node may be included in a wireless network, such as wireless network 100. In some aspects, the UE may be an HD FDD UE associated with an NTN. The UE may be a RedCap UE or an eRedCap UE.

As shown by reference number 802, the UE may receive, from the network node, a configuration associated with reading a SIB19. In some aspects, the configuration may indicate that the SIB19 should be prioritized over an uplink transmission when the uplink transmission overlaps in time with the SIB19. In some aspects, the configuration may indicate one or more SIB19 update windows. A SIB19 update window of the one or more SIB19 update windows may be configured as a multiple of an SI periodicity. The UE may be assigned to the SIB19 update window based at least in part on an explicit RRC configuration, or alternatively, the UE may be assigned to the SIB19 update window based at least in part on a defined rule based at least in part on a UE identifier (ID). In some aspects, the configuration may indicate a sub-window within an SI window associated with the SIB19. The sub-window may be based at least in part on a sub-window offset and a sub-window length.

As shown by reference number 804, the UE may monitor a downlink channel for the SIB19 reading. The UE may monitor the one or more SIB19 update windows, as indicated by the configuration. The UE may determine an SI periodicity for the SIB reading based at least in part on a parameter. The parameter may be defined in a specification, the parameter may be received via a common RRC signaling, or the parameter may be received via a UE-specific RRC signaling. Alternatively, the UE may monitor the sub-window within the SI window associated with the SIB19, as indicated by the configuration.

As shown by reference number 806, the network node may avoid an uplink scheduling that overlaps with the SIB19 update window or the sub-window within the SI window associated with the SIB19. The uplink scheduling may refer to an uplink transmission by the UE that is scheduled by the network node. The network node may avoid any uplink scheduling that conflicts with the SIB19 update window or the sub-window, such that the UE may not be forced to drop an uplink transmission in order to receive the SIB19 during the SIB19 update window or the sub-window.

As shown by reference number 808, the UE may receive, from the network node, the SIB19 based at least in part on the configuration. The SIB19 may include updated satellite ephemeris information and common TA parameters. The UE may receive the SIB19 based at least in part on the monitoring for the SIB19 reading. The UE may receive the SIB19 during one of the SIB19 update windows. Alternatively, the UE may receive the SIB19 during the sub-window within the SI window associated with the SIB19. In some aspects, an uplink interruption rate for reading the SIB19 may be specified as a number of uplink slots per an NTN uplink synchronization validity duration. The network node may transmit the SIB19 in every SI window to support a legacy non-HD FDD UE.

As shown by reference number 810, the UE may drop or cancel an uplink transmission that overlaps in time with the SIB19 based at least in part on the configuration. The uplink transmission may be associated with a dynamically or semi-statically scheduled uplink channel or signal. The UE may drop or cancel the uplink transmission based at least in part on a higher priority associated with the SIB19 in relation to the uplink transmission. The dynamically or semi-statically scheduled uplink channel or signal may be associated with one or more repetitions for a same hybrid automatic repeat request (HARQ) process identifier (ID), in which case a cancellation or a dropping may be for a whole uplink transmission of the HARQ process ID or a portion of the whole uplink transmission. In some aspects, the UE may drop or cancel an uplink transmission within the SIB19 update window, where the uplink transmission may be associated with a dynamically or semi-statically scheduled uplink channel or signal. Alternatively, an uplink transmission within the SIB19 update window and a SIB19 reception may be at different times based at least in part on a scheduling. In other words, the uplink transmission within the SIB19 update window may not overlap in time with the SIB19 reception.

In some aspects, a SIB19 update may be associated with an uplink interruption. For a SIB19 reading, the UE may be allowed to cancel/drop a dynamically or semi-statically scheduled uplink channel/signal transmission. When the uplink transmission requires repetitions for a same HARQ process ID, the cancellation/dropping may be for a whole uplink transmission of an uplink HARQ process ID or for a portion of the whole uplink transmission. A full or partial cancellation/dropping for a PUSCH repetition may be specified in a specification or configured by the network node.

In some aspects, an interruption rate may be specified as up to K times M uplink slots per ntn-UlSyncValidityDuration. The UE may monitor a Type-GA search space in all slots within an SI window associated with the SIB19. For a Type-A HD FDD UE (e.g., 13 us for Rx-to-Tx switching and Tx-to-Rx switching), M=W+1 slots. For a Type-B HD FDD UE (e.g., 1 ms for Rx-to-Tx switching and Tx-to-Rx switching), M=W+2P, where W is an SI window length and P is a number of slots per subframe. In some aspects, K is a parameter for determining a number of SI periodicities in which the UE is allowed to monitor downlink slots for the SIB19 reading, where K may be predetermined in the specification, K may be configured by the network node via common RRC signaling, or K may be configured by the network node via UE-specific RRC signaling. In one SI periodicity, one SI window may be associated with a SIB19 transmission, and the parameter K may indicate how many SI periodicities for which the UE may monitor the SIB19.

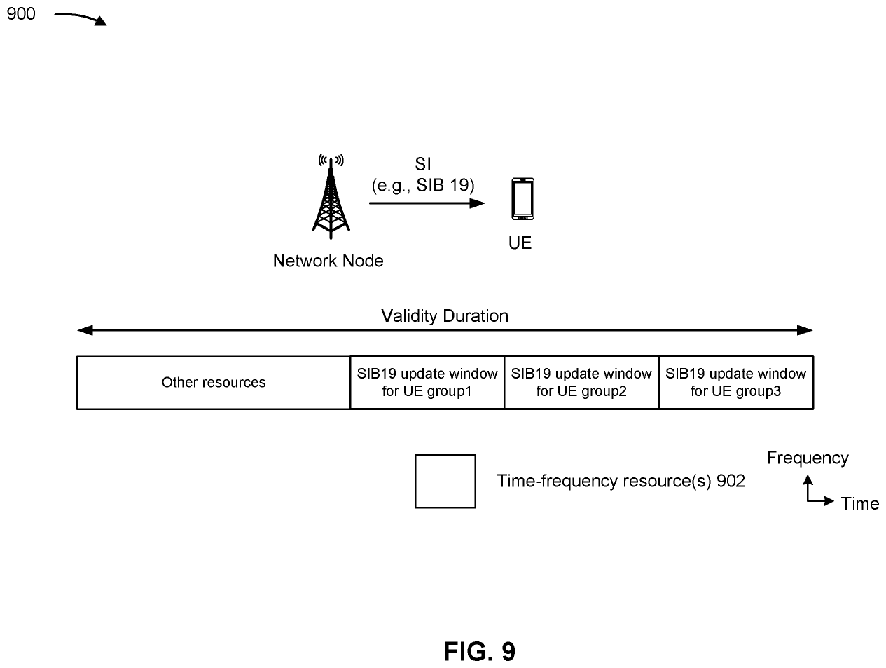

In some aspects, the network node may configure the SIB19 update window for the UE (e.g., as shown in FIG. 9). The SIB update window may be configured as a multiple of the SI periodicity. Multiple SIB19 update windows may be configured, and the UE may be assigned to one of the multiple SIB19 update windows. The UE may be associated with a specific SIB19 update window via the explicit RRC configuration. Alternatively, the UE may be associated with the specific SIB19 update window using a specification-defined rule based at least in part on the UE ID, or the UE may be assigned to the specific SIB19 update window based at least in part on a timer associated with an expiry of an uplink synchronization validity duration. The network node may determine a collision between an uplink channel/signal transmission and a SIB19 reception including a TA and Tx-Rx switching time.

In some aspects, the UE may be allowed to cancel/drop a transmission of a dynamically scheduled uplink channel/signal within the SIB19 update window. The network node may still schedule an uplink channel/signal colliding with a SIB19 reception. The UE may be allowed to drop/cancel up to K times M uplink slots within the SIB19 update window. In some aspects, the network node may not schedule an uplink channel/signal colliding with a SIB19 reception within the SIB19 update window. The SIB19 update window may be considered as a partial uplink gap. When the partial uplink gap overlaps with any configured/activated measurement gap, the UE may be allowed to prioritize the partial uplink gap to reobtain the SIB19. The partial uplink gap may include each of M consecutive slots colliding with an SI window associated with the SIB19 within the SIB19 update window.

In some aspects, as part of an SI sub-window configuration, the network node may configure the sub-window for SIB19 scheduling within the SI window. The network node may configure a relatively large SI window (e.g., 40 slots) for general SIB scheduling flexibility. Within an SI window associated with SIB19, the network node may configure an SI sub-window with a relatively small size (e.g., 2 slots) to minimize uplink interruption due to periodic SIB19 reading. A scheduling information (SchedulingInfo) information element (IE) may configure an SI sub-window offset (si-SubWindowOffset) and an SI sub-window length (si-SubWindowLength). When si-SubWindowOffset is absent, si-SubWindowOffset=0 may be assumed (e.g., a sub-window starts from a first slot within an SI window). When the sub-window is configured, an uplink interruption or an uplink scheduling restriction may be based at least in part on a sub-window length instead of an SI window length.

As shown by reference number 812, the UE may transmit, to the network node, an uplink transmission that has an uplink synchronization based at least in part on the SIB19. The uplink transmission may be associated with the uplink synchronization. The UE may apply an uplink Doppler/delay pre-compensation to achieve the uplink synchronization, which may cause the uplink transmission and other uplink transmissions transmitted by other UE to be received by the network node in a synchronous manner. The uplink synchronization may be based at least in part on the updated satellite ephemeris information and common TA parameters indicated in the SIB19.

As indicated above, FIG. 8 is provided as an example. Other examples may differ from what is described with regard to FIG. 8.

FIG. 9 is a diagram illustrating an example 900 associated with updating SI in an NTN, in accordance with the present disclosure.

As shown in FIG. 9, a network node may configure a SIB19 update window for a UE. The SIB update window may be configured as a multiple of an SI periodicity. Multiple SI update windows may be configured, and the UE may be assigned to one of the multiple SI update windows. For example, the network node may configure a SIB19 update window for a first UE group, a SIB19 update window for a second UE group, a SIB19 update window for a third UE group, and so on. Each SIB19 update window may be associated with time-frequency resources 902. The SIB19 update windows for each of the first UE group, the second UE group, and the third UE group may be within a validity duration, and a remaining portion of the validity duration may be associated with other resources. Within an SIB19 update window associated with a first UE group, the network node may schedule uplink transmission to other UE groups.

As indicated above, FIG. 9 is provided as an example. Other examples may differ from what is described with regard to FIG. 9.

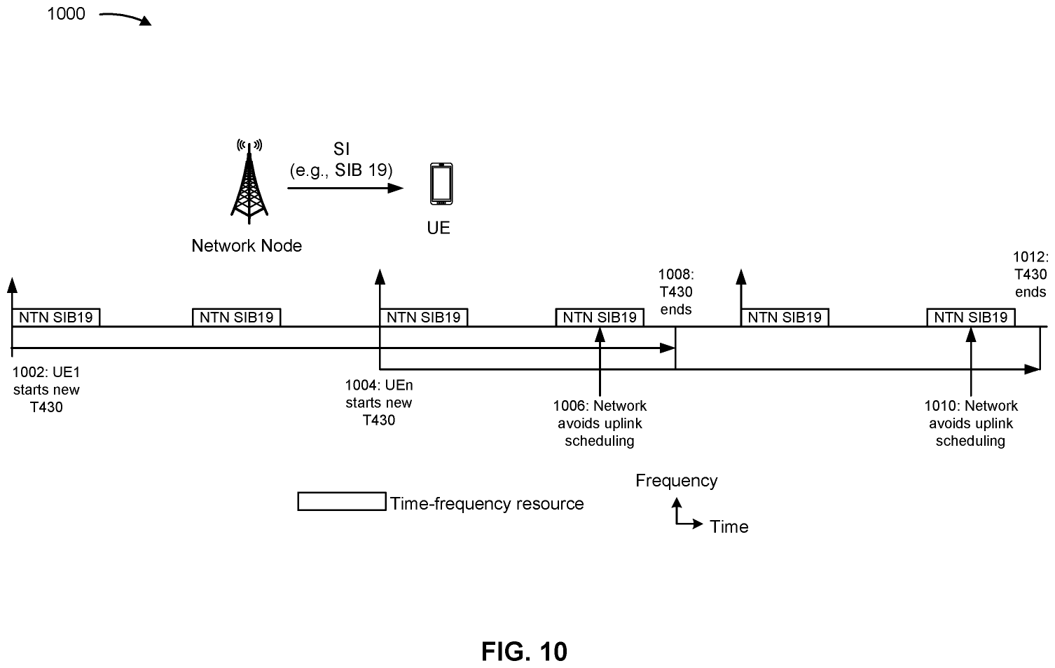

FIG. 10 is a diagram illustrating an example 1000 associated with updating SI in an NTN, in accordance with the present disclosure.

As shown in FIG. 10, a SIB19 acquisition by a UE (e.g., a RedCap UE) may be based at least in part on an epoch-time-based approach. Two epoch times may be configured to be apart by 10.24 s or an SI modification period. The UE may acquire a SIB19 in an SI window before a timer (e.g., T430) expires. A network node may avoid an uplink scheduling in every SI window before an uplink validity expiry time.

In some aspects, as shown by reference number 1002, UE1 may receive an NTN SIB19 and start a timer. As shown by reference number 1004, UEn may receive an NTN SIB19 and start a timer. As shown by reference number 1006, the network node may avoid an uplink scheduling due to an upcoming expiry of the timer associated with UE1. As shown by reference number 1008, the timer associated with UE1 may expire. As shown by reference number 1010, the network node may avoid an uplink scheduling due to an upcoming expiry of the timer associated with UEn. As shown by reference number 1012, the timer associated with UEn may expire.

In some aspects, an uplink unicast transmission (e.g., dynamically and RRC scheduled uplink transmissions, except SRS/PUCCH transmissions) may be higher priority than SIB PDSCH transmissions. The network node may indicate, to the UE, an SI window for the UE to read the SIB19 or prioritize a SIB19 reading. A downlink scheduling may be possible during the SI window, but the UE may be unable to transmit an acknowledgement (ACK) or a negative acknowledgement (NACK) via a PUCCH.

In some aspects, when the timer expires, the UE may lose an uplink synchronization and stop an uplink operation. In one example, the UE may be able to acquire the SIB19 earlier due to no uplink activity. The network node may not be aware that the UE is able to perform an uplink transmission in a certain SI window. The UE may transmit a scheduling request (SR) or a random access channel (RACH) message for uplink scheduling, which may indicate to the network node that an uplink resource may be scheduled during an upcoming SI window.

As indicated above, FIG. 10 is provided as an example. Other examples may differ from what is described with regard to FIG. 10.

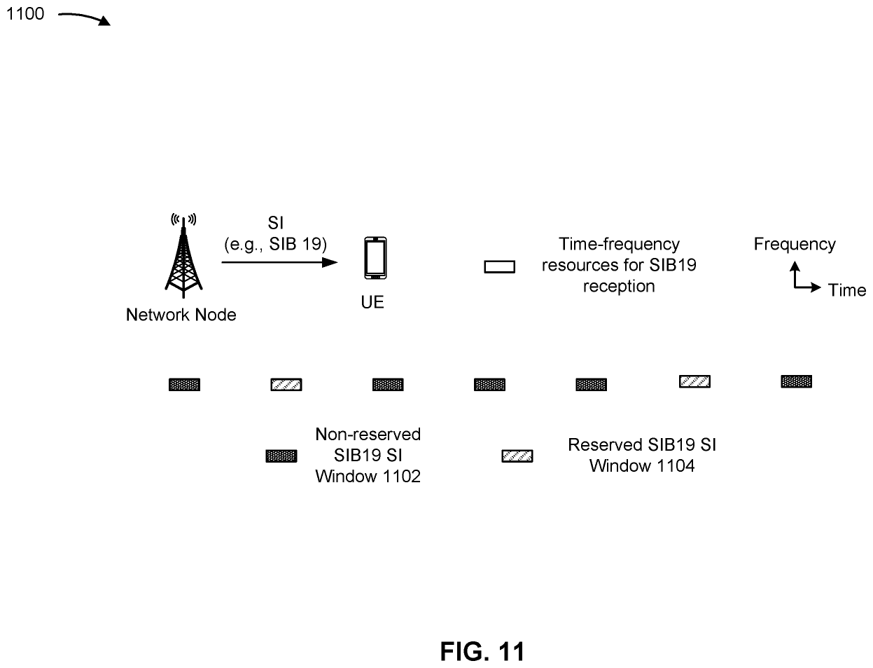

FIG. 11 is a diagram illustrating an example 1100 associated with updating SI in an NTN, in accordance with the present disclosure.

In some aspects, in an NR system, a SIB19 may be transmitted periodically during associated SI windows. The durations and start times of the SI windows may be known to a UE. In order for the UE to have sufficient time to read the SIB19, subsets of SIB19 SI windows may be configured, and during these subsets of SI windows, the UE may prioritize the reception of PDCCH and/or PDSCH transmissions for SIB19. In some aspects, a network node may configure a whole SIB19 SI window or a portion of the SIB19 SI window, during which the UE (e.g., an HD FDD UE) may drop an uplink transmission when the uplink transmission collides with a PDSCH transmission carrying the SIB19 or an associated scheduling PDCCH transmission. During a configured SIB19 SI window, the UE may follow existing collision rules or prioritize the reception of the SIB19.

As shown in FIG. 11, in a plurality of SIB19 SI windows, some of the plurality of SIB19 SI windows may be reserved SIB19 SI windows 1104. In a reserved SIB19 SI window 1104, SIB19 PDCCH and/or PDSCH transmissions may have higher priority than uplink transmissions, which may cause the uplink transmissions to be dropped in the reserved SIB19 SI window. Other SIB19 SI windows 1102 in the plurality of SIB19 SI windows may not be reserved, and thus may not be associated with higher priority for SIB19 PDCCH and/or PDSCH transmissions. Each SIB19 SI window, either reserved or not reserved, may be associated with time-frequency resources for SIB19 reception. In one example, a reserved SIB19 SI window 1104 may be less frequency than a non-reserved SIB19 SI window 1102 (e.g., one reserved SIB19 SI window out of every four SIB19 SI windows).

As indicated above, FIG. 11 is provided as an example. Other examples may differ from what is described with regard to FIG. 11.

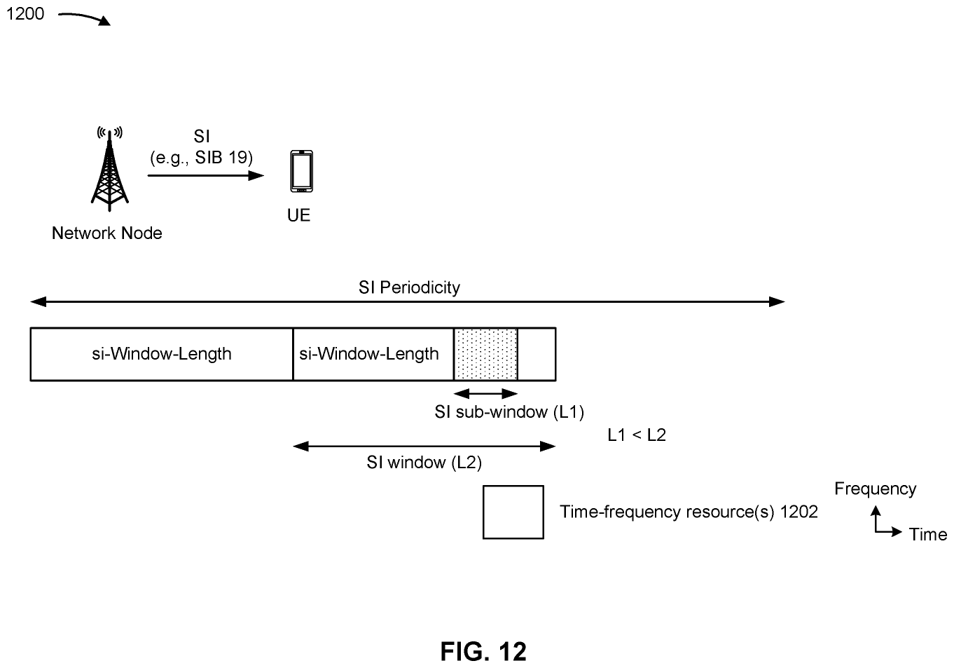

FIG. 12 is a diagram illustrating an example 1200 associated with updating SI in an NTN, in accordance with the present disclosure.

As shown in FIG. 12, an SI window for SIB19 may be associated with an SI window length. Each SI window may be associated with time-frequency resources 1202. The SI window may be associated with length L2. The SI window may be one of a plurality of SI windows within an SI periodicity. Within the SI window for SIB19, an SI sub-window may be defined. The SI sub-window may be associated with length L1, where L1 is less than L2. The SI sub-window may be configured for SIB19 scheduling. The SI sub-window may have a relatively small size (e.g., two slots) to minimize an uplink interruption due to periodic SIB19 reading.

As indicated above, FIG. 12 is provided as an example. Other examples may differ from what is described with regard to FIG. 12.

FIG. 13 is a diagram illustrating an example process 1300 performed, for example, at a UE or an apparatus of a UE, in accordance with the present disclosure. Example process 1300 is an example where the apparatus or the UE (e.g., UE 120) performs operations associated with updating SI in an NTN.

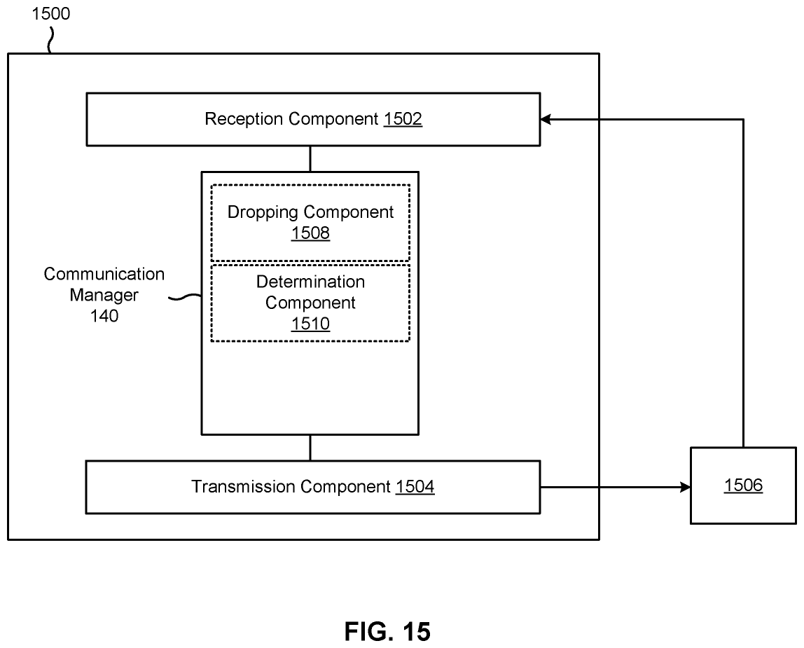

As shown in FIG. 13, in some aspects, process 1300 may include receiving a configuration associated with a SIB19 (block 1310). For example, the UE (e.g., using communication manager 140 and/or reception component 1502, depicted in FIG. 15) may receive a configuration associated with a SIB19, as described above.

As further shown in FIG. 13, in some aspects, process 1300 may include receiving the SIB19 based at least in part on the configuration (block 1320). For example, the UE (e.g., using communication manager 140 and/or reception component 1502, depicted in FIG. 15) may receive the SIB19 based at least in part on the configuration, as described above.

As further shown in FIG. 13, in some aspects, process 1300 may include transmitting an uplink transmission that has an uplink synchronization based at least in part on the SIB19 (block 1330). For example, the UE (e.g., using communication manager 140 and/or transmission component 1504, depicted in FIG. 15) may transmit an uplink transmission that has an uplink synchronization based at least in part on the SIB19, as described above.

Process 1300 may include additional aspects, such as any single aspect or any combination of aspects described below and/or in connection with one or more other processes described elsewhere herein.

In a first aspect, process 1300 includes dropping an uplink transmission that overlaps in time with the SIB19 based at least in part on the configuration, wherein the uplink transmission is associated with a dynamically or semi-statically scheduled uplink channel or signal.

In a second aspect, alone or in combination with the first aspect, the dynamically or semi-statically scheduled uplink channel or signal is associated with one or more repetitions for a same HARQ process ID, and the dropping is for an entire uplink transmission of the HARQ process ID or a portion of the entire uplink transmission.

In a third aspect, alone or in combination with one or more of the first and second aspects, an uplink interruption rate for reading the SIB19 is specified as a number of uplink slots per an NTN uplink synchronization validity duration.

In a fourth aspect, alone or in combination with one or more of the first through third aspects, process 1300 includes determining a number of SI periodicities for reading the SIB19 based at least in part on a parameter, wherein the parameter is defined in a specification, the parameter is received via a common RRC signaling, or the parameter is received via a UE-specific RRC signaling.

In a fifth aspect, alone or in combination with one or more of the first through fourth aspects, the configuration indicates one or more SIB19 update windows, wherein a SIB19 update window of the one or more SIB19 update windows is configured as a multiple of an SI periodicity, and the SIB19 update window is assigned based at least in part on an explicit RRC configuration, a defined rule based at least in part on a UE identifier, or a timer associated with an expiry of an uplink synchronization validity duration.

In a sixth aspect, alone or in combination with one or more of the first through fifth aspects, process 1300 includes dropping an uplink transmission within the SIB19 update window based at least in part on the configuration, wherein the uplink transmission is associated with a dynamically or semi-statically scheduled uplink channel or signal.

In a seventh aspect, alone or in combination with one or more of the first through sixth aspects, an uplink transmission within the SIB19 update window and a SIB19 reception are at different times based at least in part on a scheduling.

In an eighth aspect, alone or in combination with one or more of the first through seventh aspects, the configuration indicates a sub-window within an SI window associated with the SIB19, and the sub-window is based at least in part on a sub-window offset and a sub-window length.

In a ninth aspect, alone or in combination with one or more of the first through eighth aspects, the UE is an HD FDD UE in an NTN.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with updating SI in an NTN.

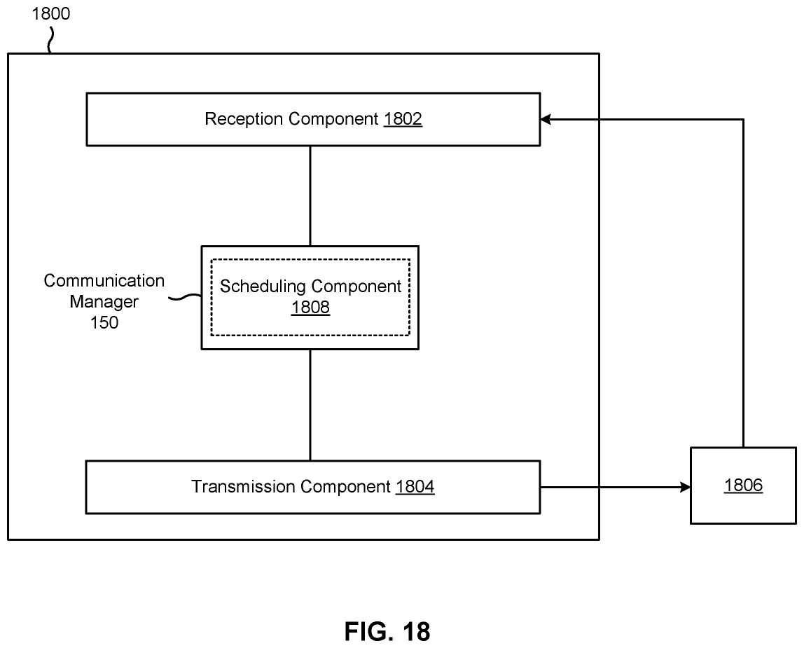

As shown in FIG. 14, in some aspects, process 1400 may include transmitting a configuration associated with a SIB19 (block 1410). For example, the network node (e.g., using communication manager 150 and/or transmission component 1804, depicted in FIG. 18) may transmit a configuration associated with a SIB19, as described above.

As further shown in FIG. 14, in some aspects, process 1400 may include receiving an uplink transmission that has an uplink synchronization based at least in part on the SIB19 (block 1420). For example, the network node (e.g., using communication manager 150 and/or reception component 1802, depicted in FIG. 18) may receive an uplink transmission that has an uplink synchronization based at least in part on the SIB19, as described above.

Process 1400 may include additional aspects, such as any single aspect or any combination of aspects described below and/or in connection with one or more other processes described elsewhere herein.

In a first aspect, the configuration indicates one or more SIB19 update windows, wherein a SIB19 update window of the one or more SIB19 update windows is configured as a multiple of an SI periodicity, and process 1400 includes assigning the SIB19 update window based at least in part on an explicit RRC configuration, a defined rule based at least in part on a UE identifier, or a timer associated with an expiry of an uplink synchronization validity duration.

In a second aspect, alone or in combination with the first aspect, process 1400 includes avoiding an uplink scheduling that overlaps with the SIB19 update window.

In a third aspect, alone or in combination with one or more of the first and second aspects, the configuration indicates a sub-window within an SI window associated with the SIB19, and the sub-window is based at least in part on a sub-window offset and a sub-window length.

In a fourth aspect, alone or in combination with one or more of the first through third aspects, process 1400 includes avoiding an uplink scheduling that overlaps with the sub-window within the SI window associated with the SIB19.

In a fifth aspect, alone or in combination with one or more of the first through fourth aspects, the network node is associated with an NTN.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 140. The communication manager 140 may include one or more of a dropping component 1508, or a determination component 1510, among other examples.

In some aspects, the apparatus 1500 may be configured to perform one or more operations described herein in connection with FIGS. 8-12. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1504 may be co-located with the reception component 1502 in one or more transceivers.

The reception component 1502 may receive a configuration associated with a SIB19. The reception component 1502 may receive the SIB19 based at least in part on the configuration. The transmission component 1504 may transmit an uplink transmission that has an uplink synchronization based at least in part on the SIB19.

The dropping component 1508 may drop an uplink transmission that overlaps in time with the SIB19 based at least in part on the configuration, wherein the uplink transmission is associated with a dynamically or semi-statically scheduled uplink channel or signal. The determination component 1510 may determine a number of SI periodicities for reading the SIB19 based at least in part on a parameter, wherein the parameter is defined in a specification, the parameter is received via a common RRC signaling, or the parameter is received via a UE-specific RRC signaling. The dropping component 1508 may drop an uplink transmission within the SI window associated with SIB19 based at least in part on the configuration, wherein the uplink transmission is associated with a dynamically or semi-statically scheduled uplink channel or signal.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

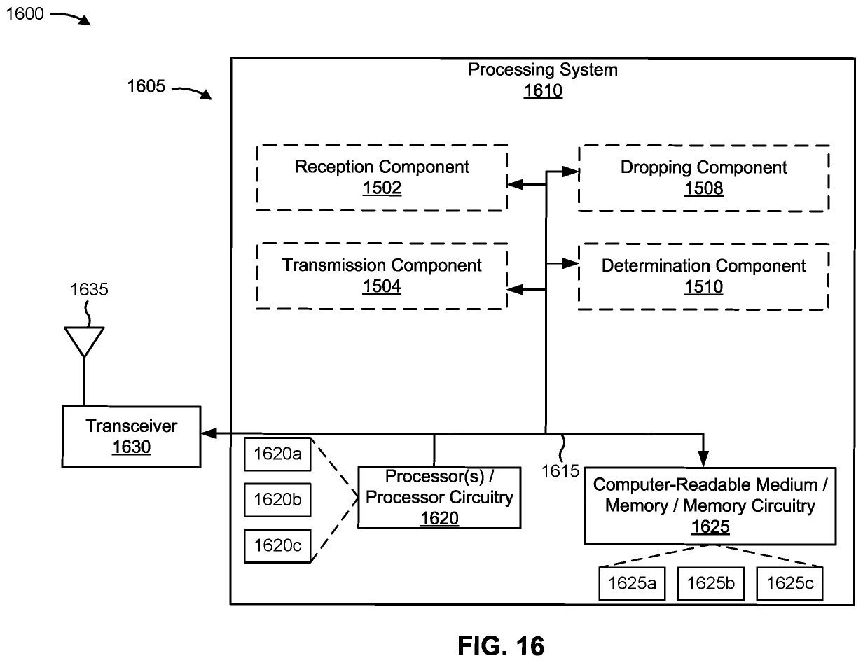

FIG. 16 is a diagram illustrating an example 1600 of a hardware implementation for an apparatus 1605 employing a processing system 1610, in accordance with the present disclosure. The apparatus 1605 may be a UE or may be at (e.g., included in) a UE.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor (or processing circuitry) 1620, the illustrated components, and the computer-readable medium/memory (or memory circuitry) 1625. The processor 1620 may include multiple processors, such as processor 1620a, memory 1620b, and memory 1620c. The memory 1625 may include multiple memories, such as memory 1625a, memory 1625b, and memory 1625c. The bus 1615 may also link various other circuits, such as timing sources, peripherals, voltage regulators, and/or power management circuits.

The processing system 1610 may be coupled to one or more transceivers 1630. A transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes one or more processors 1620 coupled to a computer-readable medium/memory 1625. A processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the UE 120 and may include one or more memories, such as the memory 282, and/or may include one or more processors, such as at least one of the TX MIMO processor 266, the RX processor 258, and/or the controller/processor 280. In some aspects, the apparatus 1605 for wireless communication includes means for receiving a configuration associated with a SIB19; means for receiving the SIB19 based at least in part on the configuration; and means for transmitting an uplink transmission that has an uplink synchronization based at least in part on the SIB19. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 16 is provided as an example. Other examples may differ from what is described in connection with FIG. 16.

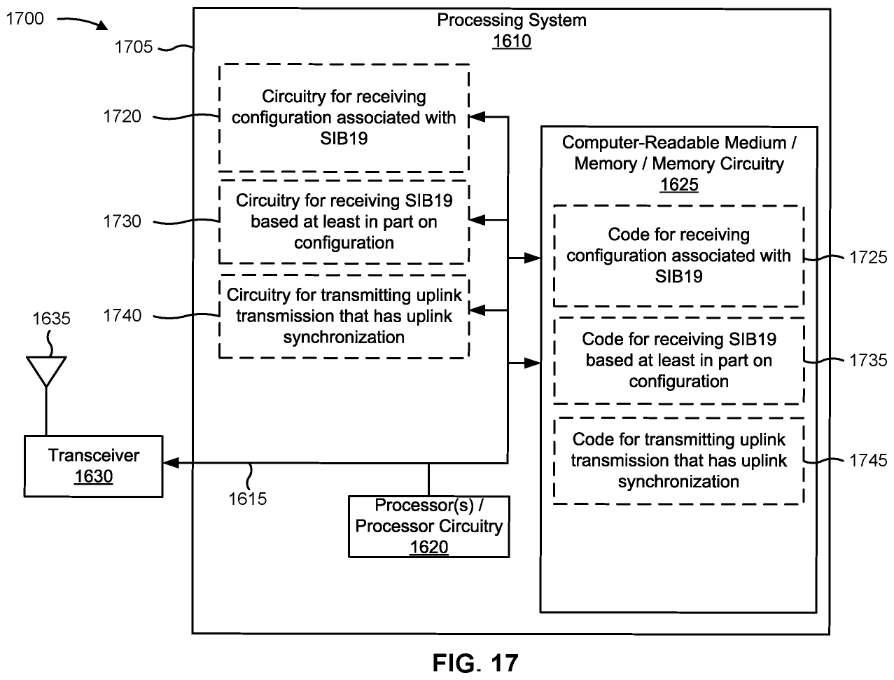

FIG. 17 is a diagram illustrating an example 1700 of an implementation of code and circuitry for an apparatus 1705, in accordance with the present disclosure. The circuitry may include processing circuitry and memory circuitry. The apparatus 1705 may be a UE, or a UE may include the apparatus 1705.

As shown in FIG. 17, the apparatus 1705 may include circuitry for receiving a configuration associated with a SIB19 (circuitry 1720). For example, the circuitry 1720 may enable the apparatus 1705 to receive a configuration associated with a SIB19.

As shown in FIG. 17, the apparatus 1705 may include, stored in computer-readable medium 1625, code for receiving a configuration associated with a SIB19 (code 1725). For example, the code 1725, when executed by processor 1620, may cause processor 1620 to cause transceiver 1630 to receive a configuration associated with a SIB19.

As shown in FIG. 17, the apparatus 1705 may include circuitry for receiving the SIB19 based at least in part on the configuration (circuitry 1730). For example, the circuitry 1730 may enable the apparatus 1705 to receive the SIB19 based at least in part on the configuration.

As shown in FIG. 17, the apparatus 1705 may include, stored in computer-readable medium 1625, code for receiving the SIB19 based at least in part on the configuration (code 1735). For example, the code 1735, when executed by processor 1620, may cause processor 1620 to cause transceiver 1630 to receive the SIB19 based at least in part on the configuration.

As shown in FIG. 17, the apparatus 1705 may include circuitry for transmitting an uplink transmission that has an uplink synchronization based at least in part on the SIB19 (circuitry 1740). For example, the circuitry 1740 may enable the apparatus 1705 to transmit an uplink transmission that has an uplink synchronization based at least in part on the SIB19.

As shown in FIG. 17, the apparatus 1705 may include, stored in computer-readable medium 1625, code for transmitting an uplink transmission that has an uplink synchronization based at least in part on the SIB19 (code 1745). For example, the code 1745, when executed by processor 1620, may cause processor 1620 to cause transceiver 1630 to transmit an uplink transmission that has an uplink synchronization based at least in part on the SIB19.

FIG. 17 is provided as an example. Other examples may differ from what is described in connection with FIG. 17.

FIG. 18 is a diagram of an example apparatus 1800 for wireless communication, in accordance with the present disclosure. The apparatus 1800 may be a network node, or a network node may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 150. The communication manager 150 may include a scheduling component 1808, among other examples.

In some aspects, the apparatus 1800 may be configured to perform one or more operations described herein in connection with FIGS. 8-12. Additionally, or alternatively, the apparatus 1800 may be configured to perform one or more processes described herein, such as process 1400 of FIG. 14, or a combination thereof. In some aspects, the apparatus 1800 and/or one or more components shown in FIG. 18 may include one or more components of the network node described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, one or more modems, one or more demodulators, one or more MIMO detectors, one or more receive processors, one or more controllers/processors, one or more memories, or a combination thereof, of the network node described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1804 may be co-located with the reception component 1802 in one or more transceivers.

The transmission component 1804 may transmit a configuration associated with a SIB19. The reception component 1802 may receive an uplink transmission that has an uplink synchronization based at least in part on the SIB19. The scheduling component 1808 may avoid an uplink scheduling that overlaps with the SIB19 update window. The scheduling component 1808 may avoid an uplink scheduling that overlaps with the sub-window within the SI window associated with the SIB19.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

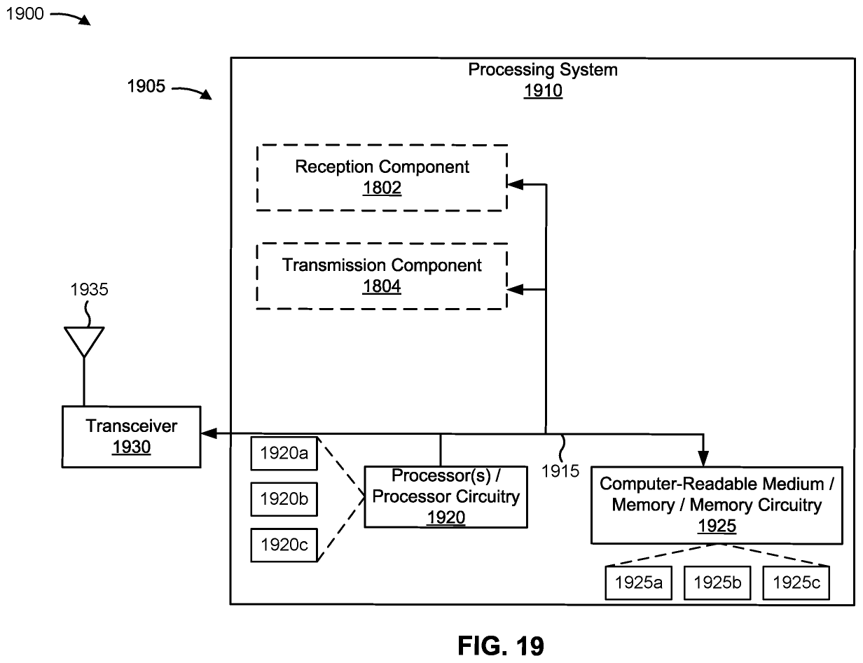

FIG. 19 is a diagram illustrating an example 1900 of a hardware implementation for an apparatus 1905 employing a processing system 1910, in accordance with the present disclosure. The apparatus 1905 may be a network node or may be at (e.g., included in) a network node.

The processing system 1910 may be implemented with a bus architecture, represented generally by the bus 1915. The bus 1915 may include any number of interconnecting buses and bridges depending on the specific application of the processing system 1910 and the overall design constraints. The bus 1915 links together various circuits including one or more processors and/or hardware components, represented by the processor (or processing circuitry) 1920, the illustrated components, and the computer-readable medium/memory (or memory circuitry) 1925. The processor 1920 may include multiple processors, such as processor 1920a, memory 1920b, and memory 1920c. The memory 1925 may include multiple memories, such as memory 1925a, memory 1925b, and memory 1925c. The bus 1915 may also link various other circuits, such as timing sources, peripherals, voltage regulators, and/or power management circuits.

The processing system 1910 may be coupled to one or more transceivers 1930. A transceiver 1930 is coupled to one or more antennas 1935. The transceiver 1930 provides a means for communicating with various other apparatuses over a transmission medium. The transceiver 1930 receives a signal from the one or more antennas 1935, extracts information from the received signal, and provides the extracted information to the processing system 1910, specifically the reception component 1802. In addition, the transceiver 1930 receives information from the processing system 1910, specifically the transmission component 1804, and generates a signal to be applied to the one or more antennas 1935 based at least in part on the received information.

The processing system 1910 includes one or more processors 1920 coupled to a computer-readable medium/memory 1925. A processor 1920 is responsible for general processing, including the execution of software stored on the computer-readable medium/memory 1925. The software, when executed by the processor 1920, causes the processing system 1910 to perform the various functions described herein for any particular apparatus. The computer-readable medium/memory 1925 may also be used for storing data that is manipulated by the processor 1920 when executing software. The processing system further includes at least one of the illustrated components. The components may be software modules running in the processor 1920, resident/stored in the computer readable medium/memory 1925, one or more hardware modules coupled to the processor 1920, or some combination thereof.

In some aspects, the processing system 1910 may be a component of the network node 110 and may include one or more memories, such as the memory 242, and/or may include one or more processors, such as at least one of the TX MIMO processor 216, the RX processor 238, and/or the controller/processor 240. In some aspects, the apparatus 1905 for wireless communication includes means for transmitting a configuration associated with a SIB19; and means for receiving an uplink transmission that has an uplink synchronization based at least in part on the SIB19. The aforementioned means may be one or more of the aforementioned components of the apparatus 1800 and/or the processing system 1910 of the apparatus 1905 configured to perform the functions recited by the aforementioned means. As described elsewhere herein, the processing system 1910 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 19 is provided as an example. Other examples may differ from what is described in connection with FIG. 19.

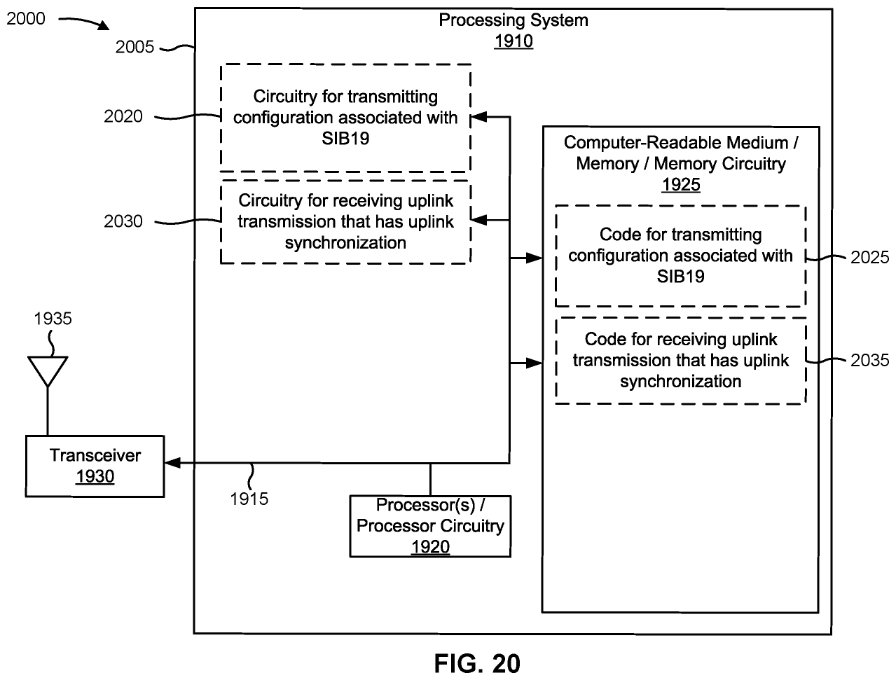

FIG. 20 is a diagram illustrating an example 2000 of an implementation of code and circuitry for an apparatus 2005, in accordance with the present disclosure. The circuitry may include processing circuitry and memory circuitry. The apparatus 2005 may be a network node, or a network node may include the apparatus 2005.

As shown in FIG. 20, the apparatus 2005 may include circuitry for transmitting a configuration associated with a SIB19 (circuitry 2020). For example, the circuitry 2020 may enable the apparatus 2005 to transmit a configuration associated with a SIB19.

As shown in FIG. 20, the apparatus 2005 may include, stored in computer-readable medium 1925, code for transmitting a configuration associated with a SIB19 (code 2025). For example, the code 2025, when executed by processor 1920, may cause processor 1920 to cause transceiver 1930 to transmit a configuration associated with a SIB19.

As shown in FIG. 20, the apparatus 2005 may include circuitry for receiving an uplink transmission that has an uplink synchronization based at least in part on the SIB19 (circuitry 2030). For example, the circuitry 2030 may enable the apparatus 2005 to receive an uplink transmission that has an uplink synchronization based at least in part on the SIB19.

As shown in FIG. 20, the apparatus 2005 may include, stored in computer-readable medium 1925, code for receiving an uplink transmission that has an uplink synchronization based at least in part on the SIB19 (code 2035). For example, the code 2035, when executed by processor 1920, may cause processor 1920 to cause transceiver 1930 to receive an uplink transmission that has an uplink synchronization based at least in part on the SIB19.

FIG. 20 is provided as an example. Other examples may differ from what is described in connection with FIG. 20.

The following provides an overview of some Aspects of the present disclosure:

Aspect 1: A method of wireless communication performed by a user equipment (UE), comprising: receiving a configuration associated with a system information block 19 (SIB19); receiving the SIB19 based at least in part on the configuration; and transmitting an uplink transmission that has an uplink synchronization based at least in part on the SIB19.

Aspect 2: The method of Aspect 1, further comprising: dropping an uplink transmission that overlaps in time with the SIB19 based at least in part on the configuration.

Aspect 3: The method of Aspect 2, wherein the uplink transmission is associated with a dynamically or semi-statically scheduled uplink channel or signal.

Aspect 4: The method of Aspect 3, wherein the dynamically or semi-statically scheduled uplink channel or signal is associated with one or more repetitions for a same hybrid automatic repeat request (HARQ) process identifier (ID).

Aspect 5: The method of Aspect 4, wherein a cancellation or a dropping is for an entire uplink transmission of the HARQ process ID or a portion of the entire uplink transmission.

Aspect 6: The method of any of Aspects 1-5, wherein an uplink interruption rate associated with a reception of the SIB19 is specified as a number of uplink slots per a non-terrestrial network (NTN) uplink synchronization validity duration.

Aspect 7: The method of any of Aspects 1-6, further comprising: determining a number of system information (SI) periodicities for reading the SIB19 based at least in part on a parameter.

Aspect 8: The method of Aspect 7, wherein the parameter is defined in a specification.

Aspect 9: The method of Aspect 7, wherein the parameter is received via a common radio resource control (RRC) signaling.

Aspect 10: The method of Aspect 7, wherein the parameter is received via a UE-specific RRC signaling.

Aspect 11: The method of any of Aspects 1-10, wherein the configuration indicates one or more SIB19 update windows.

Aspect 12: The method of Aspect 11, wherein a SIB19 update window of the one or more SIB19 update windows is configured as a multiple of a system information (SI) periodicity.

Aspect 13: The method of Aspect 12, wherein the SIB19 update window is assigned based at least in part on an explicit radio resource control (RRC) configuration, a defined rule based at least in part on a UE identifier, or a timer associated with an expiry of an uplink synchronization validity duration.

Aspect 14: The method of Aspect 13, further comprising: dropping an uplink transmission within the SIB19 update window based at least in part on the configuration.

Aspect 15: The method of Aspect 14, wherein the uplink transmission is associated with a dynamically or semi-statically scheduled uplink channel or signal.

Aspect 16: The method of Aspect 12, wherein an uplink transmission within the SIB19 update window and a SIB19 reception are at different times based at least in part on a scheduling.

Aspect 17: The method of any of Aspects 1-16, wherein the configuration indicates a sub-window within a system information (SI) window associated with the SIB19.

Aspect 18: The method of Aspect 17, wherein the sub-window is based at least in part on a sub-window offset and a sub-window length.

Aspect 19: The method of any of Aspects 1-18, wherein the UE is a half-duplex frequency division duplexing (FDD) UE in a non-terrestrial network (NTN).

Aspect 20: A method of wireless communication performed by a network node, comprising: transmitting a configuration associated with a system information block 19 (SIB19); and receiving an uplink transmission that has an uplink synchronization based at least in part on the SIB19.

Aspect 21: The method of Aspect 20, wherein the configuration indicates one or more SIB19 update windows.

Aspect 22: The method of Aspect 21, wherein a SIB19 update window of the one or more SIB19 update windows is configured as a multiple of a system information (SI) periodicity.

Aspect 23: The method of Aspect 22, further comprising: assigning the SIB19 update window based at least in part on an explicit radio resource control (RRC) configuration.

Aspect 24: The method of Aspect 22, further comprising: assigning the SIB19 update window based at least in part on a defined rule based at least in part on a UE identifier.

Aspect 25: The method of Aspect 22, further comprising: assigning the SIB19 update window based at least in part on a timer associated with an expiry of an uplink synchronization validity duration.

Aspect 26: The method of Aspect 22, further comprising: avoiding an uplink scheduling that overlaps with the SIB19 update window.

Aspect 27: The method of any of Aspects 20-26, wherein the configuration indicates a sub-window within a system information (SI) window associated with the SIB19.

Aspect 28: The method of Aspect 27, wherein the sub-window is based at least in part on a sub-window offset and a sub-window length.

Aspect 29: The method of Aspect 27, further comprising: avoiding an uplink scheduling that overlaps with the sub-window within the SI window associated with the SIB19.

Aspect 30: The method of any of Aspects 20-29, wherein the network node is associated with a non-terrestrial network (NTN).

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 32: An apparatus for wireless communication at a device, the apparatus comprising one or more memories and one or more processors coupled to the one or more memories, the one or more processors configured to cause the device to perform the method of one or more of Aspects 1-19.

Aspect 33: An apparatus for wireless communication, the apparatus comprising at least one means for performing the method of one or more of Aspects 1-19.

Aspect 34: A non-transitory computer-readable medium storing code for wireless communication, the code comprising instructions executable by one or more processors to perform the method of one or more of Aspects 1-19.

Aspect 35: A non-transitory computer-readable medium storing a set of instructions for wireless communication, the set of instructions comprising one or more instructions that, when executed by one or more processors of a device, cause the device to perform the method of one or more of Aspects 1-19.

Aspect 36: A device for wireless communication, the device comprising a processing system that includes one or more processors and one or more memories coupled with the one or more processors, the processing system configured to cause the device to perform the method of one or more of Aspects 1-19.

Aspect 37: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-19.

Aspect 38: An apparatus for wireless communication at a user equipment (UE), the apparatus comprising one or more memories and one or more processors coupled to the one or more memories, the one or more processors configured to individually or collectively cause the UE to perform the method of one or more of Aspects 1-19.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 20-30.

Aspect 40: An apparatus for wireless communication at a device, the apparatus comprising one or more memories and one or more processors coupled to the one or more memories, the one or more processors configured to cause the device to perform the method of one or more of Aspects 20-30.

Aspect 41: An apparatus for wireless communication, the apparatus comprising at least one means for performing the method of one or more of Aspects 20-30.

Aspect 42: A non-transitory computer-readable medium storing code for wireless communication, the code comprising instructions executable by one or more processors to perform the method of one or more of Aspects 20-30.

Aspect 43: A non-transitory computer-readable medium storing a set of instructions for wireless communication, the set of instructions comprising one or more instructions that, when executed by one or more processors of a device, cause the device to perform the method of one or more of Aspects 20-30.

Aspect 44: A device for wireless communication, the device comprising a processing system that includes one or more processors and one or more memories coupled with the one or more processors, the processing system configured to cause the device to perform the method of one or more of Aspects 20-30.

Aspect 45: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 20-30.

Aspect 46: An apparatus for wireless communication at a user equipment (UE), the apparatus comprising one or more memories and one or more processors coupled to the one or more memories, the one or more processors configured to individually or collectively cause the UE to perform the method of one or more of Aspects 20-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a configuration associated with a system information block 19 (SIB19);
receive the SIB19 based at least in part on the configuration; and
transmit an uplink transmission having an uplink synchronization based at least in part on the SIB19.

2. The apparatus of claim 1, wherein the one or more processors are further configured to cause the UE to:
drop an uplink transmission that overlaps in time with the SIB19 based at least in part on the configuration, wherein the uplink transmission is associated with a dynamically or semi-statically scheduled uplink channel or signal.

3. The apparatus of claim 2, wherein the dynamically or semi-statically scheduled uplink channel or signal is associated with one or more repetitions for a same hybrid automatic repeat request (HARQ) process identifier (ID), and the drop is for an entire uplink transmission of the HARQ process ID or a portion of the entire uplink transmission.

4. The apparatus of claim 2, wherein an uplink interruption rate associated with a reception of the SIB19 is specified as a number of uplink slots per a non-terrestrial network (NTN) uplink synchronization validity duration.

5. The apparatus of claim 4, wherein the one or more processors are further configured to cause the UE to:
determine a number of system information (SI) periodicities based at least in part on a parameter, wherein the parameter is defined in a specification, the parameter is received via a common radio resource control (RRC) signaling, or the parameter is received via a UE-specific RRC signaling.

6. The apparatus of claim 1, wherein the configuration indicates one or more SIB19 update windows, wherein a SIB19 update window of the one or more SIB19 update windows is configured as a multiple of a system information (SI) periodicity, and the SIB19 update window is assigned based at least in part on an explicit radio resource control (RRC) configuration, a defined rule based at least in part on a UE identifier, or a timer associated with an expiry of an uplink synchronization validity duration.

7. The apparatus of claim 6, wherein the one or more processors are further configured to cause the UE to:
drop an uplink transmission within the SIB19 update window based at least in part on the configuration, wherein the uplink transmission is associated with a dynamically or semi-statically scheduled uplink channel or signal.

8. The apparatus of claim 6, wherein an uplink transmission within the SIB19 update window and a SIB19 reception are at different times based at least in part on a scheduling.

9. The apparatus of claim 1, wherein the configuration indicates a sub-window within a system information (SI) window associated with the SIB19, and the sub-window is based at least in part on a sub-window offset and a sub-window length.

10. The apparatus of claim 1, wherein the UE is a half-duplex frequency division duplexing (FDD) UE in a non-terrestrial network (NTN).

11. An apparatus for wireless communication at a network node, comprising:
one or more memories; and
one or more processors, coupled to the one or more memories, configured to cause the network node to:
transmit a configuration associated with a system information block 19 (SIB19); and
receive an uplink transmission that has an uplink synchronization based at least in part on the SIB19.

12. The apparatus of claim 11, wherein the configuration indicates one or more SIB19 update windows, wherein a SIB19 update window of the one or more SIB19 update windows is configured as a multiple of a system information (SI) periodicity, and the one or more processors are further configured to cause the network node to:
assign the SIB19 update window based at least in part on an explicit radio resource control (RRC) configuration, a defined rule based at least in part on a UE identifier, or a timer associated with an expiry of an uplink synchronization validity duration.

13. The apparatus of claim 12, wherein the one or more processors are further configured to cause the network node to:
avoid an uplink scheduling that overlaps with the SIB19 update window.

14. The apparatus of claim 11, wherein the configuration indicates a sub-window within a system information (SI) window associated with the SIB19, and the sub-window is based at least in part on a sub-window offset and a sub-window length.

15. The apparatus of claim 14, wherein the one or more processors are further configured to cause the network node to:
avoid an uplink scheduling that overlaps with the sub-window within the SI window associated with the SIB19.

16. The apparatus of claim 11, wherein the network node is associated with a non-terrestrial network (NTN).

17. A method of wireless communication performed by a user equipment (UE), comprising:
receiving a configuration associated with a system information block 19 (SIB19);
receiving the SIB19 based at least in part on the configuration; and
transmitting an uplink transmission that has an uplink synchronization based at least in part on the SIB19.

18. The method of claim 17, further comprising:
dropping an uplink transmission that overlaps in time with the SIB19 based at least in part on the configuration, wherein the uplink transmission is associated with a dynamically or semi-statically scheduled uplink channel or signal.

19. The method of claim 17, wherein the configuration indicates one or more SIB19 update windows, wherein a SIB19 update window of the one or more SIB19 update windows is configured as a multiple of a system information (SI) periodicity, and the SIB19 update window is assigned based at least in part on an explicit radio resource control (RRC) configuration, a defined rule based at least in part on a UE identifier, or a timer associated with an expiry of an uplink synchronization validity duration.

20. The method of claim 17, wherein the configuration indicates a sub-window within a system information (SI) window associated with the SIB19, and the sub-window is based at least in part on a sub-window offset and a sub-window length.
